(19) United States
(12) Patent Application Publication
(10) Pub. No.: US 2004/0173985 A1
(43) Pub. Date: Sep. 9, 2004

(54) Device for the roll stabilization of vehicles

(76) Inventors: Hubert Bruhl, Waldstetten (DE); Karl-Heinz Ross, Ebersbach (DE); Peter Tattermusch, Esslingen (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/758,587

(22) Filed: Jan. 15, 2004

Related U.S. Application Data
(63) Continuation-in-part of application No. PCT/EP02/04843, filed on May 3, 2002.

(30) Foreign Application Priority Data
Jul. 17, 2001 (DE) 101 34 715.4

(51) Int. Cl. B60G 1/00

(52) U.S. Cl. 280/124.106

(57) ABSTRACT

In a device for minimizing the roll movement of vehicle bodies having rigid axles or independent suspensions, with a non-torsion bar mounted pivotably on the vehicle body and oriented approximately transversely to the vehicle longitudinal direction, and two parallel cantilever arms disposed approximately horizontally in a neutral position of the vehicle, essentially vertically oriented spring/damper units are supported between free ends of the cantilever arms and the vehicle wheel suspensions, the spring/damper units being cylinder/piston units filled with a hydraulic fluid, with the pistons in the cylinder/piston units being centered, free of play, so as to be pre-stressed between springs.

This is a Continuation-In-Part of International application PCT/EP02/04843 filed May 03, 2002 and claiming the priority of German application 101 34 715.4 filed Jul. 17, 2001.

### BACKGROUND OF THE INVENTION

The invention relates to a device for minimizing the roll movement of vehicles with rigid axles and independent suspensions, with a torsion-resistant bar mounted pivotably on the vehicle body and oriented approximately transversely to the vehicle longitudinal direction. Two parallel and bend-resistant cantilever arms, which are approximately horizontal in the vehicle neutral position, extend from the opposite ends of this bar and at least approximately vertically oriented spring/damper units are connected to the free ends of the cantilever arms. Each spring/damper unit is operatively connected to the rigid axle or to a wheel-guide structure of an independent suspension of a vehicle axle.

DE 198 40 619 C1 discloses a passive roll damping arrangement with at least one damper per vehicle axle. This device consists for example of a torsion bar stabilizer mounted pivotably on the vehicle body. The torsion stabilizer has two lever arms, which are arranged in an approximately horizontal position and are connected at their free ends to wheel-guiding parts via a coupling rod. A rigid coupling rod with cantilever arms is arranged parallel to this torsion stabilizer. The free ends of these cantilever arms are connected via at least one damper to the same wheel guide parts as the coupling rods of the torsion stabilizer.

It is the object of the present invention to provide a device for minimizing the roll movement in vehicles, which is largely independent of the damping and spring characteristics of the vehicle suspension.

### SUMMARY OF THE INVENTION

In a device for minimizing the roll movement of vehicle bodies having rigid axles or independent suspensions, with a non-torsion bar mounted pivotably on the vehicle body and oriented approximately transversely to the vehicle longitudinal direction, and two parallel cantilever arms disposed approximately horizontally in a neutral position of the vehicle, essentially vertically oriented spring/damper units are supported between free ends of the cantilever arms and the vehicle wheel suspensions, the spring/damper units being cylinder/piston units filled with a hydraulic fluid, with the pistons in the cylinder/piston units being centered, free of play, so as to be pre-stressed between springs.

The spring/damper units include hydraulic cylinder units forming dampers which are each subdivided into two cylinder chambers by a piston disposed approximately centrally in a cylinder unit. Valves acting reciprocally in the piston are provided for damping the fluid flowing through transfer passages between the cylinder spaces. For simpler assembly and to minimize the construction space required, the functions of roll springing and roll damping are effectively combined in the components arranged in parallel in each cylinder unit.

The stabilizers normally used for the roll control which are generally in the form of torsion springs are in this case provided by means of pre-stressed compression springs in the cylinder housings of the spring/damper units. The two springs of a cylinder/piston hold a piston centered in the cylinder housing, so that it is located approximately in a central position which is connected via a piston rod to one arm of a coupling stirrup consisting of the member and of its cantilever arms. The cylinder housing is connected, for example, directly to wheel-guide parts of the rigid axle or of the independent suspension. The combined spring/damper units and also arrangements of a plurality of such spring/damper units one behind the other or next to one another or in combinations of arrangements lying next to one another and one behind the other provide for a multiplicity of different possibilities for coordinating the vehicle-specific properties.

The compression springs can be selected or adapted to the requirements depending on their properties, for example by variations in the spring wire geometries, material properties, number of spring turns or a plurality of cooperating springs as spring assemblies. The use of pneumatic springs makes it possible to have even continuous adaptations via corresponding gas pressures. Elastomer springs may also be considered as compression springs.

The spring/damper can be tuned with regard to damping by particular configurations of the fluid transfer pressures and of the valves in the pistons, the piston rods or cylinders of the cylinder/piston units. The cross-sections of the fluid transfer passages may be designed in different ways include continuously adjustable diaphragms. Here too, combinations of fluid transfer passages disposed next to one another and one behind the other may be used. Where electrically activated and switched valves are concerned, flow paths can be combined with one another in different ways.

An embodiment of the invention will be described below in greater detail on the basis of the accompanying drawings.

### BRIEF DESCRIPTION OF THE DRAWINGS

FIG. 1 shows a torsion bar coupling yoke with wheel-side spring/damper elements, and

FIG. 2 shows in a cross-sectional view an illustration of a spring/damper element.

### DESCRIPTION OF A PREFERRED EMBODIMENT

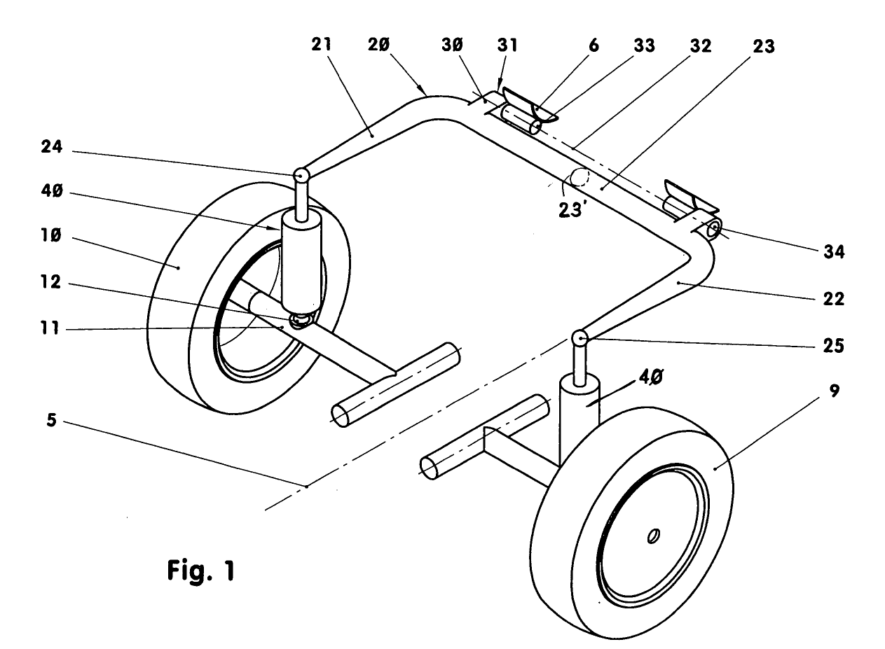

FIG. 1 shows an arrangement for reducing the roll in curves on the front and/or rear axles or bogies of vehicles, consisting of a coupling yoke (20) with spring/damper units (40) which are arranged at the ends of the yoke and which serve as connecting members between wheel-suspension parts (11) and the coupling yoke (20).

The coupling yoke (20) is constructed from a torsion-resistant member (23) extending approximately transversely to the vehicle longitudinal axle (5) and having cantilever arms (21, 22) mounted at its ends. These cantilever arms (21, 22) are bend-resistant and torsion-resistant components which are firmly connected to the member (23) so as to extend approximately horizontally, for example parallel to the longitudinal vehicle axis (5), at least in the design position. Two bearing arms (30) are located, opposite the free ends of the cantilever arms (21, 22), on the member (23) and are provided at their free ends with joint lugs (34). Joint pins (33) extend through these joint lugs (34) and are connected firmly to the vehicle body (6). The two pairings of joint lugs (34) and joint pins (33) are located on a common pivot axis (32).

The free ends of the cantilever arms (21, 22) are each connected to wheel-guide components (11) via a spring/damper unit (40), for example, by ball joints (12, 24). The wheel-guide components (11) support and guide the wheel (10) during compression and rebound and accommodate also side forces. The components are not illustrated here; they may include wheel carriers, links, struts, springs, and dampers.

The spring/damper units (40) may be mounted on one of the wheel-guide components (11) listed, the individual spring/damper unit (40) being arranged in an approximately vertical position between the wheel-guide components (11) and the coupling yoke (20).

During compression or rebound of the wheels (10) on one side, the movement of the wheels (10) is transmitted via the spring/damper units (40) to the cantilever arms (21, 22) of the coupling stirrup (20). The latter in this case also pivots about the pivot axis (32) according to the compression and rebound movement.

Due to the kinematics of the wheel-guiding parts (11) and to the pivoting range of the coupling yoke (20), spatial displacements of the articulation points (12, 24) may occur. Depending on the selected location of these articulation points (12, 24), it is possible to keep these displacements very small.

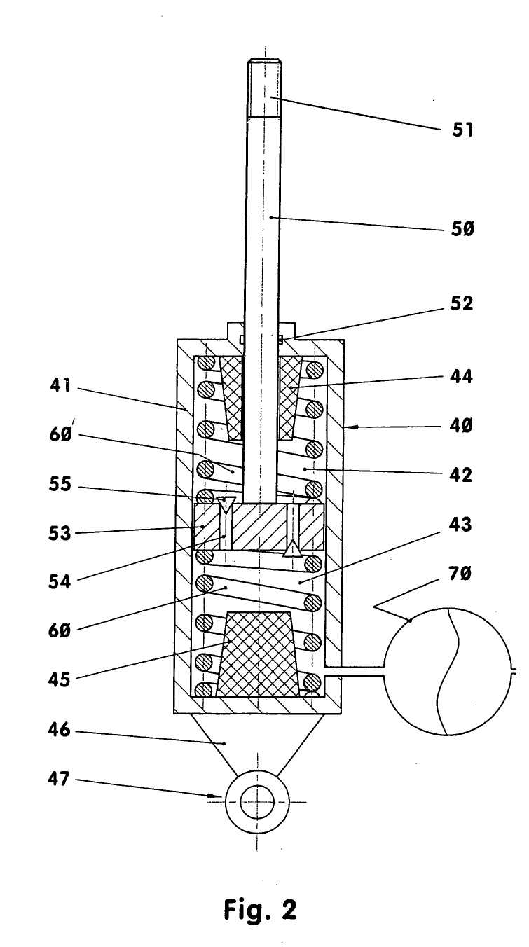

In the event of alternating compression and rebound, of the opposite wheels the forces and movements occurring are transmitted via the coupling yoke (20) from one wheel (10) to the other wheel (9). If, for example, as illustrated in FIG. 1, the rear wheel (10) on the left in FIG. 1 is moved upwardly, the spring/damper unit (40) on this side or, according to FIG. 2, the lower helical spring (60) is subjected to compressive stress. The pressure force is transmitted correspondingly to the spring/damper unit (40) of the cantilever arm (22) via the piston rod (50) and the cantilever arm (21) and the member (23) to the spring/damper unit 40′ of the wheel 9. In this spring/damper unit (40′), then, the upper helical spring (60′) is subjected to compressive stress. The latter attempts to press the wheel (9) located on this side upwardly.

The rod member (23) and the cantilever arms (21, 22) are dimensionally stable components. The coupling yoke (20) is not comparable in this respect to a torsion bar stabilizer. All elasticities are displaced into the spring/damper units (40, 40′), cf. FIG. 2.

The reasons for such a resilient transmission of the compression and rebound forces are comfort and safety, since, in the event of non-resilient and non-damped transmissions of rolling movements, driving instability may arise, for example, due to jolts or an overshoot behavior. A correspondingly smooth onset of roll transmissions of this kind is desirable for the vehicle occupants from the point of view of comfort.

For one-sided load states, the same conditions apply as in the case of alternating compression and rebound, since in this case, there is also a one-sided compression.

With the aid of an adjusting drive, not illustrated, in the form of a pivot control motor or of a control cylinder, the coupling yoke (20) may, if appropriate, be pivoted out of its approximately horizontal position. This adjustment allows, for example, adaptation to a level control. In this way, appropriately adapted response behavior of the roll stabilization can be implemented for specific driving conditions.

A coupling yoke (20) divided for example in their center (23′) in the plane of the vehicle longitudinal axis (5) constitutes a further variant. The divided halves of this coupling yoke are likewise rigid components, which can be pivotally adjusted relative to one another by means of active actuators.

FIG. 2 is a sectional illustration of the spring/damper unit (40). A spring/damper unit (40) of this type is installed, in FIG. 1, between the wheel-guide components (11) and the coupling yoke (20). The spring/damper unit (40) comprises a cylinder housing (41), which is connected at one end to a joint pin of a wheel-guide component (11) via a holder (46) and, for example, a joint lug (47).

According to FIG. 1, a joint ball is seated in a joint socket, cf. ball joint (12). A piston (53) and a piston rod (50) are guided in the cylinder housing (41). The piston rod (50) has at its free end a thread (51) for connection to a ball joint (24) of a cantilever arm (21, 22). The piston (53) is maintained under pre-stress in an approximately central position of the cylinder housing (41) by two compression springs (60). The compression springs (60) are supported axially each on one piston end face and on an inner cylinder end face.

In the center position, the piston (53) divides the cylinder inner space into two cylinder spaces (42, 43) of approximately equal size. These cylinder spaces (42, 43) are in communication with each other via flow passages (54) which extend through the piston (53) and include valves (55). During compression or rebound of the piston (53), fluid can flow from one cylinder space (42, 43) into the other cylinder space (42, 43) via these valves (55).

When, in the event of compression and rebound, the piston (53) moves into the cylinder space (42, 43) corresponding to the movement, the spring (60) located in this cylinder space (42, 43) is compressed. During this movement, fluid flows through the passage (54) and the valve (55) out of this cylinder space (42, 43) into the adjacent cylinder space (43, 42). The narrow passage (54) and the flow resistance of the valve (55) damp this movement.

The valves (55) are assigned to the passages (54) in such a way that, depending on the direction of movement, one valve (55) opens and one valve (55) closes. It is, of course, possible that a plurality of identical valves (55) with direction-dependent action can be arranged in equal or different numbers in the piston (53).

Furthermore, a plurality of passages (54) arranged one behind the other and having different cross-sections and lengths and also different valves (55) may be used in connection with the piston (53).

Different damping values can thus be provided and the valves (55) can be controllable mechanically or electrically. When a Theological fluid is used, the valves (55) may be eliminated since the flow resistance is controlled via the variable viscosity of the damping fluid. The viscosity may be controlled electrically via the cylinder housing (41) or the piston (53) or via both components (41, 53). The current is supplied to the piston (53) in this case via the piston rod (50).

In order to achieve a different spring constants, different springs (60) may be used for example in terms of material, wire geometry, number of turns and number of springs (60). Different spring constants and damping can thus be predetermined for compression and rebound, thereby allowing an individual coordination of the combination or roll spring and roll damping. Additional special adaptation is possible by the choice of different spring travel lengths and of different volumes of the cylinder spaces (42, 43).

With maximum displacement of the piston (53) in the compression or rebound direction, the piston end faces engage compression and rebound stops (44, 45). These compression and rebound stops (44, 45) may be in the form of a spring or an elastomer body or both. They serve for damping the end positions of the piston (53). When such a compression and rebound stop (44, 45) is reached in one direction of action, a virtually rigid connection is made between wheel-guide part (11) and coupling yoke (10). Movements and accelerations are then transmitted directly.

In order to provide volume compensation for the retracting piston rod (50), for example a hydraulic accumulator (70) is used. A flexible cylinder wall or a pressure release valve leading to a pressure vessel or a tank may also be used. A further alternative for achieving equal volumes of the cylinder spaces (42, 43) is to use a continuous piston rod extending through both cylinder chambers.

What is claimed is:

1. A device for minimizing the roll movements of a vehicle body with wheel suspensions, including:
a torsion-resistant rod member (23) which is mounted pivotably on the vehicle body (6) and is oriented approximately transversely to the vehicle longitudinal direction, said rod member (23) having at the two ends,
two parallel and bend-resistant cantilever arms (21, 22) connected to said opposite ends and extending approximately horizontally from said opposite ends when the vehicle is in a neutral position, each cantilever arm (21, 22) having a free end, and
an approximately vertically oriented spring/damper unit (40, 40′) articulated to each of said free ends and operatively connected to an axle or wheel-guide component of a wheel suspension of the vehicle,
each of said spring/damper units (40) comprising a cylinder/piston structure (40, 40′) filled being with a hydraulic fluid, with
the piston (53) of the individual cylinder/piston structure (40, 40′) being centered, free of play, in the respective cylinder (41) so as to be pre-stressed between at least two spring elements (60).

2. The device as claimed in claim 1, wherein the rod member (23) and the cantilever arms (21, 22) form a one-part coupling yoke (20).

3. The device as claimed in claim 1, wherein separate communication passages with at least one automatically opening throttle valve (55) extend through said piston (53) for each direction of piston movement of said piston (53).

4. The device as claimed in claim 1, wherein the damping fluid is a Theological fluid, and the valves (55) can be controlled by at least one of mechanical, electrical or magnetic field means.

5. The device as claimed in claim 1, wherein the coupling yoke (20) is pivotally supported on the vehicle body by bearings (31).

6. The device as claimed in claim 1, wherein the coupling yoke (20) is divided in the plane of the vehicle longitudinal axis (5) into yoke parts, and these coupling yoke parts are pivotably supported independently of one another.
